(19) United States
(12) Patent Application Publication
(10) Pub. No.: US 2023/0401611 A1
(43) Pub. Date: Dec. 14, 2023

(54) VEHICLE VALUE PREDICTION DEVICE

(71) Applicant: TOYOTA JIDOSHA KABUSHIKI KAISHA, Aichi-ken (JP)

(72) Inventors: Yusuke KUZUYA, Nagoya-shi (JP); Kenji YAMAGUCHI, Miyoshi-shi (JP)

(21) Appl. No.: 18/296,372

(22) Filed: Apr. 6, 2023

(30) Foreign Application Priority Data
Jun. 14, 2022 (JP) 2022-095701

(51) Int. Cl. G06Q 30/02

(52) U.S. Cl. CPC G06Q 30/0278

(57) ABSTRACT

A vehicle value prediction device includes: a vehicle information value calculation unit calculating a time-series change in vehicle information; an equipment value calculation unit calculating a time-series change in equipment value; an engine value calculation unit that calculates a time-series change in engine value; a skeleton value calculation unit that calculates a time-series change in skeleton value; an exterior value calculation unit that calculates a time-series change in exterior value; an interior value calculation unit that calculates a time-series change in interior value; a vehicle value calculation unit that calculates a time-series change in vehicle value by integrating time-series changes in vehicle information value, equipment value, engine value, skeleton value, exterior value, and interior value from a purchase time of a vehicle to present; and a vehicle value prediction unit that calculates a vehicle value of a predetermined period destination based on the time-series change in vehicle value.

### CROSS-REFERENCE TO RELATED APPLICATION

This application claims priority to Japanese Patent Application No. 2022-095701 filed on Jun. 14, 2022, incorporated herein by reference in its entirety.

### BACKGROUND

### 1. Technical Field

The present disclosure relates to a vehicle value prediction device that calculates vehicle value of a vehicle in a predetermined period ahead.

### 2. Description of Related Art

The vehicle value of a so-called used vehicle is determined according to the number of years elapsed since the time of purchase as a new vehicle, the traveling distance, the vehicle state, and the like. For example, Japanese Unexamined Patent Application Publication No. 2002-366829 (JP 2002-366829 A) discloses a method for determining the overall value data indicating the overall value as a used vehicle, based on the internal value data determined based on the driving situation data and external value data determined based on the specifications of the vehicle and the like.

### SUMMARY

However, according to the above-described method, the vehicle value of the vehicle in a predetermined period ahead cannot be obtained. If the vehicle value of the vehicle in a predetermined period ahead is known, the vehicle currently used can be pre-sorted, pre-sold, or the like. In addition, a buyer is found from the time of ownership of the vehicle, allowing transaction to be made in real time.

Therefore, the present disclosure provides a vehicle value prediction device capable of calculating the vehicle value of a vehicle in a predetermined period ahead.

A vehicle value prediction device according to an aspect of the present disclosure is a vehicle value prediction device that predicts vehicle value of a vehicle in a predetermined period ahead, and includes: a vehicle information value calculation unit that acquires a history of vehicle information of the vehicle to calculate a time-series change in value based on the vehicle information; an equipment value calculation unit that acquires a history of equipment of the vehicle to calculate a time-series change in equipment value; an engine value calculation unit that acquires a history of an engine of the vehicle to calculate a time-series change in engine value; a skeleton value calculation unit that acquires a history of a skeleton of the vehicle to calculate a time-series change in skeleton value; an exterior value calculation unit that acquires a history of an exterior of the vehicle to calculate a time-series change in exterior value; an interior value calculation unit that acquires a history of an interior of the vehicle to calculate a time-series change in interior value; a vehicle value calculation unit that calculates a time-series change in the vehicle value by integrating the time-series changes in the vehicle information value, the equipment value, the engine value, the skeleton value, the exterior value, and the interior value from a time of purchase of the vehicle to the present; and a vehicle value prediction unit that calculates the vehicle value in the predetermined period ahead based on the time-series change in the vehicle value.

In the vehicle value prediction device of the above aspect, the engine value calculation unit preferably acquires a state of the engine from the vehicle in real time to calculate the time-series change in the engine value.

In the vehicle value prediction device of the above aspect, the exterior value calculation unit preferably acquires, from a dealer or a maintenance shop, whether there is a scratch, a dent, deterioration of paint, and a repair of the scratch or the dent in the exterior of the vehicle to calculate the time-series change in the exterior value.

In the vehicle value prediction device of the above aspect, the interior value calculation unit preferably acquires, from a dealer or a maintenance shop, a stain or deterioration in the interior of the vehicle to calculate the time-series change in the interior value.

According to the vehicle value prediction device of the present disclosure, it is possible to calculate the vehicle value of the vehicle in the predetermined period ahead.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a concept of a vehicle value prediction device that is an example of an embodiment;

FIG. 2 is a block diagram illustrating a configuration of a vehicle value prediction device and each server that sends information to the vehicle value prediction device, which is an example of the embodiment;

FIG. 3 is a block diagram illustrating a configuration of a vehicle value prediction device that is an example of the embodiment;

FIG. 4 is a flowchart illustrating a flow of an operation of a vehicle value prediction device according to an exemplary embodiment; and

FIG. 5 is a schematic diagram illustrating a flow of an operation of a vehicle value prediction device that is an example of the embodiment.

### DETAILED DESCRIPTION OF EMBODIMENTS

Hereinafter, an example of the embodiment of the present disclosure will be described in detail. In the following description, specific shapes, materials, directions, numerical values, and the like are examples for facilitating the understanding of the present disclosure, and can be appropriately changed according to applications, purposes, specifications, and the like.

Vehicle Value Prediction Device

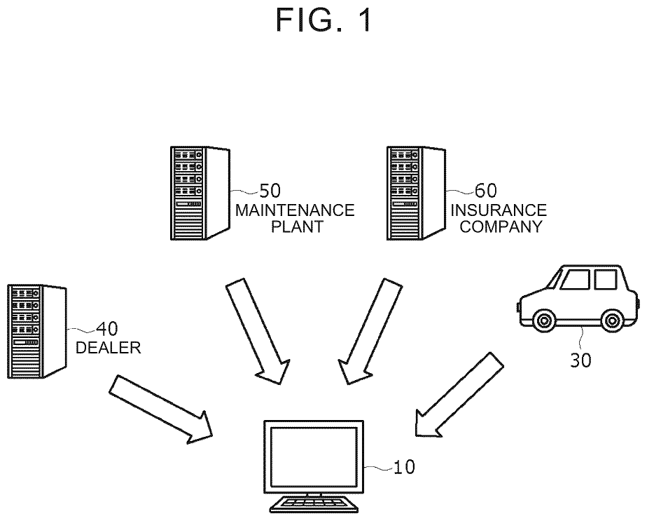

The vehicle value prediction device 10 will be described with reference to FIGS. 1 to 3.

The vehicle value prediction device 10 divides the vehicle value of the vehicle 30 into a value based on vehicle information, an equipment value, an engine value, a skeleton value, an exterior value, and an interior value, which will be described in detail later. The vehicle value prediction device 10 can calculate a time-series change of each value, integrate the time-series change of each value, calculate a time-series change of the vehicle value, and predict a vehicle value of a predetermined period destination.

According to the vehicle value prediction device 10, it is possible to obtain the vehicle value of the vehicle 30 in a predetermined period ahead. Therefore, it is possible to perform pre-sorting, pre-sale, and the like of the currently used vehicle 30. In addition, a real-time transaction can be performed by the buyer from the time of ownership of the vehicle 30.

In the present embodiment, the vehicle value is the value of the vehicle 30 based on the point in time when the vehicle 30 is purchased as a new vehicle. The vehicle value may be the price of the vehicle 30 as a used vehicle in the market. In the present embodiment, the vehicle 30 is a four-wheel engine vehicle, but the present disclosure is not limited thereto. The vehicle 30 may be an electrified vehicle or a hybrid electric vehicle. The vehicle 30 is preferably a connected car having a function of always connecting to the Internet.

In the present embodiment, the vehicle value prediction device 10 is owned by a used vehicle dealer that sells used vehicles, but is not limited thereto. The vehicle value prediction device 10 may be owned by, for example, an owner of the vehicle 30, may be owned by an automobile manufacturer who manufactures the vehicle 30, or may be owned by a dealer who sells the vehicle 30.

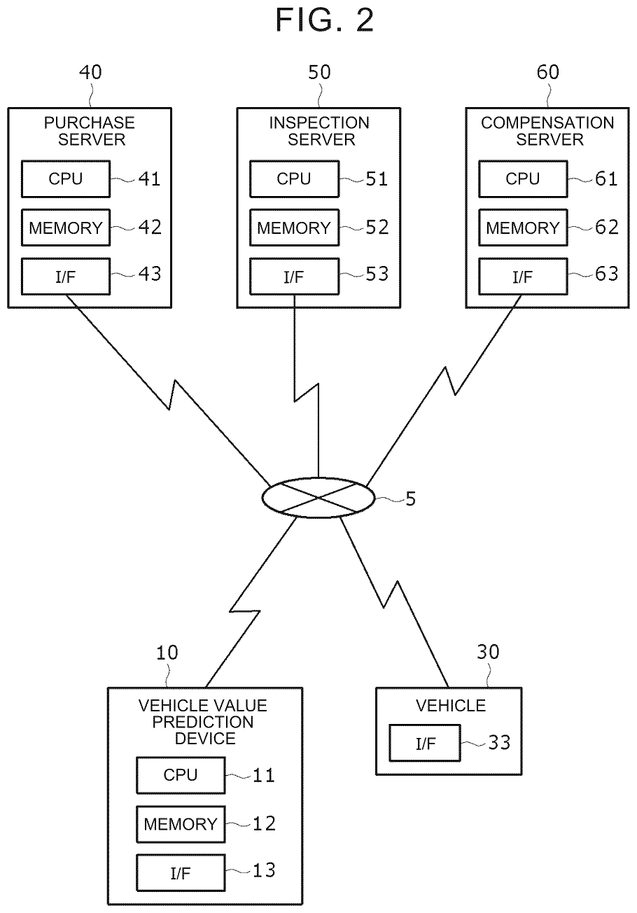

As shown in FIG. 1, the vehicle value prediction device 10 is connected to a vehicle 30, a purchase server 40 provided in, for example, a dealer, which will be described in detail later, an inspection server 50 provided in, for example, a maintenance factory, a compensation server 60 provided in, for example, an insurance company, and a communication line 5 (see FIG. 2). The vehicle value prediction device 10 obtains information from the vehicle 30, the purchase server 40, the inspection server 50, and the compensation server 60 to calculate the time-series changes in the value, equipment value, organization value, skeleton value, exterior value, and interior value due to the vehicle information described above.

As illustrated in FIG. 2, the vehicle value prediction device 10 is a computer having a processor 11 having a CPU for performing information processing, a memory 12 for storing software, programs, or data executed by the processor 11, and a network interface 13 connectable to the communication line 5.

The vehicle 30 has a network interface 33 connectable to the communication line 5.

The purchase server 40 provides information at the time of purchase of the vehicle 30 to the vehicle value prediction device 10. The purchase server 40 may be provided in an automobile manufacturer or may be provided in a dealer. The purchase server 40 is a computer having a processor 41 having a CPU for performing information processing, a memory 42 for storing software, programs, or data executed by the processor 41, and a network interface 43 connectable to the communication line 5.

The inspection server 50 provides the vehicle value prediction device 10 with information at the time of inspection of the vehicle 30. The inspection server 50 may be provided in a shop that performs inspection, or may be provided in a maintenance factory. The inspection server 50 is a computer having a processor 51 having a CPU for performing information processing, a memory 52 for storing software, programs, or data executed by the processor 51, and a network interface 53 connectable to the communication line 5.

The compensation server 60 provides information at the time of compensation of the vehicle 30 to the vehicle value prediction device 10. The compensation server 60 may be provided in a maintenance factory or may be provided in an insurance company. The compensation server 60 is a computer having a processor 61 having a CPU for performing information processing, a memory 62 for storing software, programs, or data to be executed by the processor 61, and a network interface 63 connectable to the communication line 5.

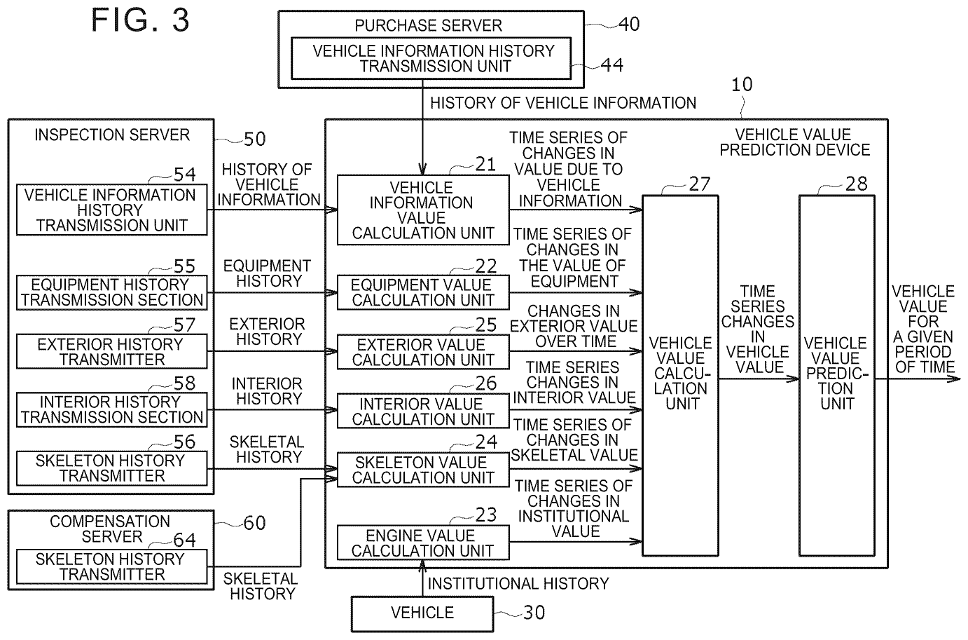

As shown in FIG. 3, the vehicle value prediction device 10 includes a vehicle information value calculation unit 21, an equipment value calculation unit 22, an engine value calculation unit 23, a skeleton value calculation unit 24, an exterior value calculation unit 25, an interior value calculation unit 26, a vehicle value calculation unit 27, and a vehicle value prediction unit 28, which will be described in detail later. The vehicle information value calculation unit 21, the equipment value calculation unit 22, the engine value calculation unit 23, the skeleton value calculation unit 24, the exterior value calculation unit 25, the interior value calculation unit 26, the vehicle value calculation unit 27, and the vehicle value prediction unit 28 are realized by the processor 11 executing a program stored in the memory 12.

The vehicle information value calculation unit 21 acquires the history of the vehicle information of the vehicle 30 from the time of purchase to the current time, and calculates the time-series change of the value based on the vehicle information based on the history of the vehicle information. The vehicle information value calculation unit 21 acquires the history of the vehicle information from the purchase server 40 and the inspection server 50.

The vehicle information is basic information of the vehicle 30, and includes a vehicle type and a grade of the vehicle 30, a use area of the vehicle 30, characteristics of a user of the vehicle 30, and the like. The history of the vehicle information is a record of the use area of the vehicle 30 and the change of the user of the vehicle 30.

The value based on the vehicle information is a value obtained by quantifying the vehicle type, the grade, the use area of the vehicle 30, the characteristics of the user of the vehicle 30, and the like. The time-series change of the value based on the vehicle information is a quantitative representation of the time-series change of the value based on the vehicle information based on the history of the vehicle information. The time-series change of the value according to the vehicle information is a time-series graph descending according to the elapsed years, and is preferably expressed by a mathematical expression.

The time series change of the value according to the vehicle type and the grade may be calculated based on the price at the time of purchase and the price of the used vehicle market thereafter. The time-series change of the value according to the vehicle information according to the use area may be calculated as the value according to the vehicle information falls more quickly than in the other areas, since the aging deterioration due to the salt damage is expected in the area close to the sea, for example. The time-series change in the value according to the vehicle information by the user may be calculated as a slower decrease in the value according to the vehicle information than the other users, since it is predicted that the vehicle is driven gently, for example, if the user is an elderly person.

The equipment value calculation unit 22 acquires the history of the equipment of the vehicle 30 from the time of purchase to the current time, and calculates the time-series change of the equipment value based on the history of the equipment. The equipment value calculation unit 22 acquires a history of equipment from the purchase server 40 and the inspection server 50.

The equipment is equipment (optional equipment) to be set at an additional cost other than the standard equipment of the vehicle 30, and includes, for example, a sunroof, a car navigation device, a back camera, and the like. The equipment history is a record of addition of equipment determined at the time of purchase of the vehicle 30 and subsequent equipment. The addition of equipment also includes, for example, an update of the car navigation device.

The equipment value is obtained by quantifying the presence or absence of equipment other than the standard equipment of the vehicle 30. Time-series changes in equipment value are quantitative representations of time-series changes in equipment value based on equipment history. For example, the time-series change of the equipment value may be calculated such that the time-series change of the equipment value increases in a stepwise manner by updating the software of the car navigation system.

The engine value calculation unit 23 acquires the history of the engine of the vehicle 30 from the time of purchase to the current time, and calculates the time-series change of the engine value based on the history of the engine. The engine value calculation unit 23 acquires the history of the engine in real time from the vehicle 30 via the communication line 5.

The engine is an engine in the case of an engine vehicle, and is an electric motor and a battery in the case of an electrified vehicle. The institution's history is a record of the institution's status. The state of the engine includes a traveling distance, a traveling state, and the like in the case of the engine. The traveling state includes a depression time of the accelerator, an idling time of the engine, and the like. In addition, the engine state includes a state of charge of the battery in the case of an electric motor. The charging state of the battery includes a time when the battery is empty, a battery temperature at the time of charging, and the like.

Institutional value is a quantification of the state of an institution. Time-series changes in institution value are quantitative representations of time-series changes in institution value based on the institution's history. The time-series change of the institution value is a time-series graph descending according to the elapsed years, and is preferably expressed by a mathematical expression.

The time-series change in the engine value may be calculated, for example, as the engine value rapidly decreases when the depression time of the accelerator is long and the emptying time of the engine is long. For example, in the case of a battery, when the time in which the battery is empty is long and the battery temperature at the time of charging is low, it may be calculated that the engine value is rapidly lowered.

The skeleton value calculation unit 24 acquires the history of the skeleton of the vehicle 30 from the time of purchase of the vehicle 30 to the current time, and calculates the time-series change of the skeleton value based on the history of the skeleton. The skeleton value calculation unit 24 acquires the history of the skeleton from the inspection server 50 and the compensation server 60.

The skeleton is a frame portion that maintains the strength of the vehicle 30. The history of the skeleton is a record of repairs of the skeleton. Skeletal value is a quantification of whether or not a skeleton has been repaired. The time series change of the skeleton value is a quantitative representation of the time series change of the skeleton value based on the history of the skeleton. For example, by repairing the skeleton, the time-series change of the skeleton value may be calculated so as to decrease in a stepwise manner.

The exterior value calculation unit 25 acquires the history of the exterior of the vehicle 30 from the time of purchase of the vehicle 30 to the present, and calculates the time-series change of the exterior value based on the history of the exterior. The exterior value calculation unit 25 acquires the history of the exterior from the inspection server 50.

The exterior is a decoration and a part on the outside of the vehicle body of the vehicle 30. The history of the exterior is a record of scratches, dents, discoloration of the paint, repairs thereof, and the like of the exterior. The exterior value is a quantification of scratches, dents, discoloration of paint, repairs, etc. of the exterior. The time series change of the exterior value is a quantitative representation of the time series change of the exterior value based on the history of the exterior. For example, when the scratch of the bumper is repaired, the time-series change of the exterior value may be calculated so as to decrease in a stepwise manner. Further, the color fading degree of the painting of the body may be quantified, and the time-series change of the exterior value may be calculated so as to gradually decrease.

The interior value calculation unit 26 acquires the history of the interior of the vehicle 30 from the time of purchase of the vehicle 30 to the present, and calculates a time-series change in the interior value based on the history of the interior. The interior value calculation unit 26 acquires an interior history from the inspection server 50.

The interior is a decoration and a part on the inside of the vehicle 30. The history of the interior is a record of deterioration, dirt, and the like of the interior. The interior value is a quantification of deterioration, dirt, and the like of the interior. The time series change of the interior value is a quantitative representation of the time series change of the interior value based on the history of the interior. For example, when the seat of the seat is replaced, the time-series change of the interior value may be calculated so as to increase in a stepwise manner. Further, the degree of contamination of the interior may be quantified, and the time-series change of the interior value may be calculated so as to gradually decrease.

The vehicle value calculation unit 27 calculates the time-series change of the vehicle value by integrating the time-series change of the value based on the vehicle information, the time-series change of the value of the equipment, the time-series change of the value of the engine, the time-series change of the value of the skeleton, the time-series change of the value of the exterior, and the time-series change of the value of the interior. The time-series change of the vehicle value is a time-series graph descending according to the elapsed years, and is preferably expressed by a mathematical expression.

The vehicle value prediction unit 28 calculates the vehicle value of the predetermined period destination based on the time-series change of the vehicle value described above. According to the vehicle value prediction unit 28, it is possible to obtain the vehicle value of the vehicle 30 ahead of a predetermined period of time. In this way, if the vehicle value of the vehicle 30 ahead of a predetermined period is known, the vehicle 30 currently being used can be pre-sorted, pre-sold, or the like. In addition, a real-time transaction can be performed by the buyer from the time of ownership of the vehicle 30.

The purchase server 40 includes a vehicle information transmission unit 44 that transmits the above-described history of vehicle information. The vehicle information transmission unit 44 is realized by the processor 41 executing a program stored in the memory 42.

The inspection server 50 includes a vehicle information transmission unit 54 that transmits the history of the vehicle information, an equipment history transmission unit 55 that transmits the history of the above-described equipment, a skeleton history transmission unit 56 that transmits the history of the above-described skeleton, an exterior history transmission unit 57 that transmits the history of the above-described exterior, and an interior history transmission unit 58 that transmits the history of the above-described interior. The vehicle information transmission unit 54, the equipment history transmission unit 55, the skeleton history transmission unit 56, the exterior history transmission unit 57, and the interior history transmission unit 58 are realized by the processor 51 executing a program stored in the memory 52.

The compensation server 60 includes a skeleton history transmitting unit 64 that transmits the skeleton history described above. The skeleton history transmitting unit 64 is realized by the processor 61 executing a program stored in the memory 62.

Flow of Operation of Vehicle Value Prediction Device

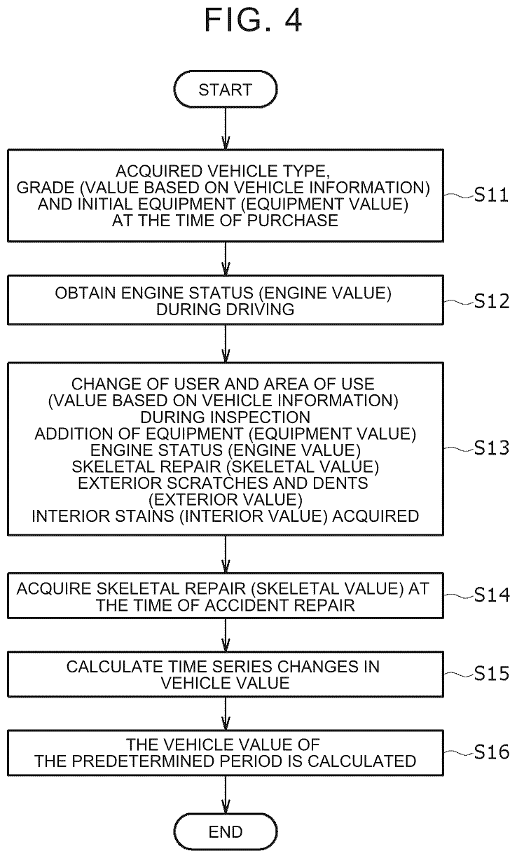

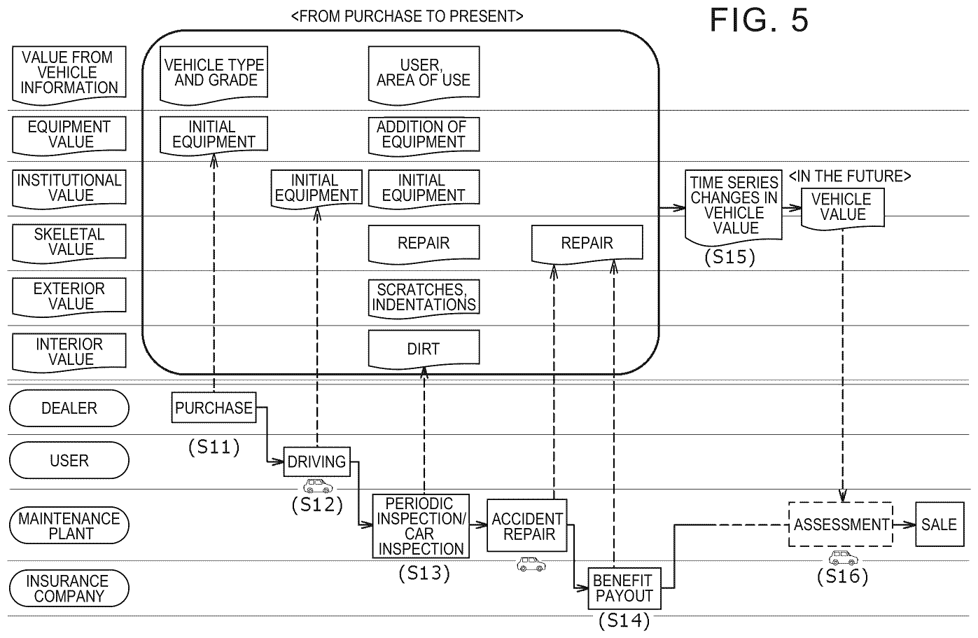

The flow of the operation of the vehicle value prediction device 10 will be described with reference to FIGS. 4 and 5.

In the step S11, when the vehicle 30 is purchased, the vehicle information value calculation unit 21 acquires the vehicle type and the grade of the vehicle 30. The equipment value calculation unit 22 acquires the initial equipment of the vehicle 30. In the step S12, when the vehicle 30 is traveling, the engine value calculation unit 23 acquires the condition of the engine of the vehicle 30 from the vehicle 30 in real time.

In S13 of steps, at the time of inspection of the vehicle 30, the vehicle information value calculation unit 21 acquires the change of the user of the vehicle 30 or the use area. The equipment value calculation unit 22 acquires the addition of the equipment of the vehicle 30 as the history of the equipment. The engine value calculation unit 23 acquires the inspection result of the engine as the history of the engine. When the frame is repaired, the skeleton value calculation unit 24 acquires the frame as a skeleton history. The exterior value calculation unit 25 acquires, as a history of the exterior, scratches, dents, discoloration of the paint, repairs thereof, and the like of the exterior. The interior value calculation unit 26 acquires stains and deterioration of the interior as a history of the interior.

In S14 of steps, when the vehicle 30 is repaired, the skeleton value calculation unit 24 acquires whether or not the skeleton is repaired as a history of the skeleton.

In the step S15, when calculating the predetermined period ahead value of the vehicle 30, the vehicle value calculation unit 27 calculates the time series change of the value based on the vehicle information described above, the time series change of the value of the equipment, the time series change of the engine value, the time series change of the value of the skeleton, the time series change of the value of the exterior, and the time series change of the value of the interior by integrating the time series change of the vehicle value.

In the step S16, the vehicle value prediction unit 28 calculates the vehicle value of the predetermined period-ahead based on the time-series change of the vehicle value described above.

It should be noted that the present disclosure is not limited to the above-described embodiments and modifications thereof, and it goes without saying that various changes and improvements can be made within the scope of the matters described in the claims of the present application.

What is claimed is:

1. A vehicle value prediction device that predicts vehicle value of a vehicle in a predetermined period ahead, the vehicle value prediction device comprising:
a vehicle information value calculation unit that acquires a history of vehicle information of the vehicle to calculate a time-series change in value based on the vehicle information;
an equipment value calculation unit that acquires a history of equipment of the vehicle to calculate a time-series change in equipment value;
an engine value calculation unit that acquires a history of an engine of the vehicle to calculate a time-series change in engine value;
a skeleton value calculation unit that acquires a history of a skeleton of the vehicle to calculate a time-series change in skeleton value;
an exterior value calculation unit that acquires a history of an exterior of the vehicle to calculate a time-series change in exterior value;
an interior value calculation unit that acquires a history of an interior of the vehicle to calculate a time-series change in interior value;
a vehicle value calculation unit that calculates a time-series change in the vehicle value by integrating the time-series changes in the vehicle information value, the equipment value, the engine value, the skeleton value, the exterior value, and the interior value from a time of purchase of the vehicle to present; and
a vehicle value prediction unit that calculates the vehicle value in the predetermined period ahead based on the time-series change in the vehicle value.

2. The vehicle value prediction device according to claim 1, wherein the engine value calculation unit acquires a state of the engine from the vehicle in real time to calculate the time-series change in the engine value.

3. The vehicle value prediction device according to claim 1, wherein the exterior value calculation unit acquires, from a dealer or a maintenance shop, whether there is a scratch, a dent, deterioration of paint, and a repair of the scratch or the dent in the exterior of the vehicle to calculate the time-series change in the exterior value.

4. The vehicle value prediction device according to claim 1, wherein the interior value calculation unit acquires, from a dealer or a maintenance shop, a stain or deterioration in the interior of the vehicle to calculate the time-series change in the interior value.
